(19) United States
(12) Patent Application Publication
(10) Pub. No.: US 2007/0113453 A1
(43) Pub. Date: May 24, 2007

(54) Tag for supporting a bag on a dispensing apparatus

(75) Inventor: Adam Dickinson, Staffordshire (GB)

Correspondence Address: BARNES & THORNBURG LLP, 11 SOUTH MERIDIAN, INDIANAPOLIS, IN, 46204, US

(73) Assignee: EURO PACKAGING LTD.

(21) Appl. No.: 10/555,556

(22) PCT Filed: May 6, 2004
(86) PCT No.: PCT/GB04/01961

§ 371 Date: Aug. 22, 2006

(30) Foreign Application Priority Data
May 6, 2003 (GB) 0310246.4
Nov. 7, 2003 (GB) 0326060.1

(51) Int. Cl. G09F 3/10

(52) U.S. Cl. 40/673

(57) ABSTRACT

A tag (10) for supporting part of a bag on a bag dispensing apparatus, the tag comprising a body (12) having a dispensing apparatus attachment formation (16) at one end to allow attachment of the tag to dispensing apparatus and a bag attachment formation (28) at the other end to allow attachment of a tag to part of a bag. A bag comprising a body (52) having a closed base and closed side walls, handle members (56, 58) and an open mouth end (54), the bag further comprising two apertures adjacent the mouth end of the bag between the handle members and a weakened portion of bag material between the apertures.

The invention relates to a tag for supporting part of a bag on a bag dispensing apparatus and particularly but not exclusively limited to use on bag dispensing apparatus in retail establishments at the point of sale for packaging purchased goods.

Stacks of bags are commonly provided in retail establishments at the point of sale to allow a customer to package purchased goods. Such bags are generally made of thin-walled flexible plastics material and are sealed at the base ends and sides leaving the upper end open to form the mouth of a bag. There are various designs of such bags. One common configuration includes two handle members which extend upwardly from the mouth of the bag, one on each side of the bag. Such a configuration is commonly known as a “vest bag” or “vest style bag”.

Vest style bags of the type described are often mounted on a dispensing apparatus. A variety of dispensing apparatus are known. One such apparatus comprises a housing which is arranged at the point of sale having two elongate pins which are spaced apart by a distance equal to the distance between the centre lines of the handles of the bag to be supported on the dispensing apparatus. The pins are arranged to extend through holes arranged through the respective handles of the bags to be supported on the dispensing system. A projection extends from the housing, generally midway between the two pins looking in plan and arranged slightly below the pins. The projection extends parallel with the pins and generally has a hook-like formation at its free end. The projection is arranged to extend through a further aperture on the bag so as to support the centre part of the bag. The two pins are longer than the central projection so that the ends of the pins terminate beyond the end of the projection. When the stack of bags is arranged on the dispensing apparatus described above, the pins extend through all of the holes in the respective handles in the bags of the stack and the central projection extends through apertures arranged at the mouth of the bag. The stack of bags is generally arranged so that the rear face of each bag is semi-permanently attached, for example by means of adhesive, by welding or by mechanical attachment, to the front face of the subsequent bag in the stack. When a user comes to package purchased goods, the front bag is pulled so that the front face of the bag clears the hooked end of the projection, allowing the front wall to be pulled forwardly and the bag opened. The handles of the front most bag slide forwardly along the pins but due to the fact that the pins extend for a greater distance than the projection the bag is still supported by the pins. The bag is then retained open on the housing by the pins whilst the user packages the purchased goods. Once the bag is filled, the user can pull the two handle members so that the handle members ride off the pins. The rear face of the bag then clears the hook-like projection which then acts to retain the front face of the subsequent bag with sufficient force to allow further pulling of the front bag to cause the semi-permanent attachment between the rear and front faces of the front most and subsequent bags to fail. At that point the bag is released. In the more preferred arrangement the removal of the front most bag from the dispensing apparatus causes the front wall of the subsequent bag to be pulled forward so that the bag is presented open to the user to receive purchased goods. An example of such an arrangement is shown in U.S. Pat. No. 5,335,788. In U.S. Pat. No. 5,335,788, the bags have a tab which projects upwardly of the mouth and the tab is provided with an aperture through which the hook protrusion extends. The tab is connected to the mouth of a bag by means of a perforated line so that pulling of the bag from the dispensing apparatus causes the perforations to fail which leaves the tab hanging on the hook protrusion. That arrangement is undesirable because the leaving of the residue of the body of the bag on the dispensing apparatus after removal of the bag has proven a health and safety hazard, for example because the tab of bag material can find its way on to the floor presenting the risk that a person may slip on the bag material. Accordingly, various solutions have been proposed to address that. For example, in U.S. Pat. No. 5,188,235, the hook projection extends through an aperture at the mouth of the bag and a perforated line extends from the aperture to the upper edge of the mouth so that pulling of the bag causes the perforated line to fail, leaving no bag material on the hooked projection. A similar arrangement is shown in U.S. Pat. No. 5,979,841. However, that arrangement results in a tear in the upper edge of the bag and when the bag is heavily loaded the tear can progress and cause the bag to fail. This means that the bag must be made from heavier duty material which increases the bag cost.

A further problem arises in the known systems in that the dispensing apparatus requires two pins and a curved projection to correlate with apertures in a stack of individual bags. It is necessary to ensure that the apertures in the individual bags are aligned with other apertures in bags of a stack so as to allow a store operative, more readily to locate the stack on the dispensing apparatus without obstruction from misaligned apertures throughout the depth of the bag stack. A further problem which arises in mounting the mouth part of the bag on the central hooked projection is that the projection must be shorter than the pins in order to effect proper opening of the bag to allow the bag to be loaded and the fact that the projection is shorter limits the maximum numbers of bags which can be mounted on the dispensing apparatus. This decreases the efficiency of the dispensing unit as the dispenser unit needs to be revisited more frequently to replenish it with stacks of bags.

It is an objection of the invention to provide an improved bag dispensing arrangement.

According to a first aspect of the invention there is provided a tag for supporting part of a bag on a bag dispensing apparatus, the tag comprising a body having a dispensing apparatus attachment formation at one end to allow attachment of the tag to dispensing apparatus and a bag attachment formation at the other end to allow attachment of a tag to part of a bag.

In that way, the central part of the bag can be supported by the tag, which in turn is connected to the dispensing apparatus. Accordingly, no bag residue is left on the dispensing apparatus. Also, because each tag can carry multiple bags, the constraint on the number of bags carried by the dispensing apparatus is removed, enabling more bags to be located on the apparatus.

The dispensing apparatus attachment formation preferably comprises an aperture in the tag body to allow a projecting member of the dispensing apparatus to pass therethrough.

The projecting member of the dispensing apparatus may comprise a looped projection. In such a case, the aperture in the tag body may include a tongue which is arranged to project into the loop when the projection passes through the aperture. Preferably, the looped projection comprises two substantially parallel spaced arms with a connecting bight portion. The aperture most preferably comprises two arm apertures spaced apart by the same distance as the spaced arms and being dimensioned to allow a respective arm therethrough with a clearance and a slot connecting the two arm apertures together. In that way, a tongue is naturally formed between the two arm apertures. In order to locate the tag on the dispensing apparatus, the projection is pushed through the aperture such that the bight portion deforms the tongue and the arms are received through the arm apertures. The tongue then moves over the bight portion so as to extend into the space between the arms. That configuration aids retention of the tag on the dispensing apparatus as bags are removed therefrom.

The bag attachment formation preferably comprises an arrowhead formation at the end of the tag body which can project through an aperture in the bag, whereby the widest point of the arrowhead is wider than the bag aperture. The bag may thus be provided with means to allow the aperture to fail when the bag is pulled from the dispensing apparatus.

Alternatively, the arrowhead formation may project through one aperture in the bag and back through another aperture. Still further, a slit may be provided in the body of the tag so that the arrowhead may project through a first bag aperture, back through a second bag aperture and then through the slit in the body of the tab to retain the bags on the tag. Where two bag apertures are provided, a weakened portion may be provided between the apertures to effect failure of that part when the bag is pulled from the dispensing apparatus. The weakened portion may comprise a perforated line.

The tag is preferably made from flexible plastics material. The plastics material is selected to be stronger than the bag material, either due to its greater thickness or greater inherent strength.

The material is preferably resilient such that the tongue arrangement described above snaps into the space between the arms. The arrowhead arrangement preferably also snaps through the slit in the tag body.

That arrangement is preferable because the tongue will cause a positive “click” sound on correct installation onto the dispensing apparatus which ensures that users load the tags correctly.

The tag most preferably comprises a dispensing apparatus attachment formation having two arm apertures connected by a slot so as to define a tongue therebetween at one end of the body and a bag attachment formation having an arrowhead and slit combination at the other end of the body.

According to another aspect of the invention, there is provided a bag comprising a body having a closed base and closed side walls, handle members and an open mouth end, the bag further comprising two apertures adjacent the mouth end of the bag between the handle members and a weakened portion of bag material between the apertures.

Preferably, the bag has a tag as described above attached thereto. A stack of bags may be received in that way.

According to a third aspect of the invention, there is provided a stack of bags attached to a tag according to the first aspect or any of the subsistory clauses thereto.

According to a fourth aspect of the invention, there is provided a dispensing apparatus carrying a stack of bags having a separate tag connecting the stack of bags with the dispensing apparatus.

A tag, a bag and stack of bags in accordance with the invention will now be described in detail by way of example and with reference to the accompanying drawings, in which:

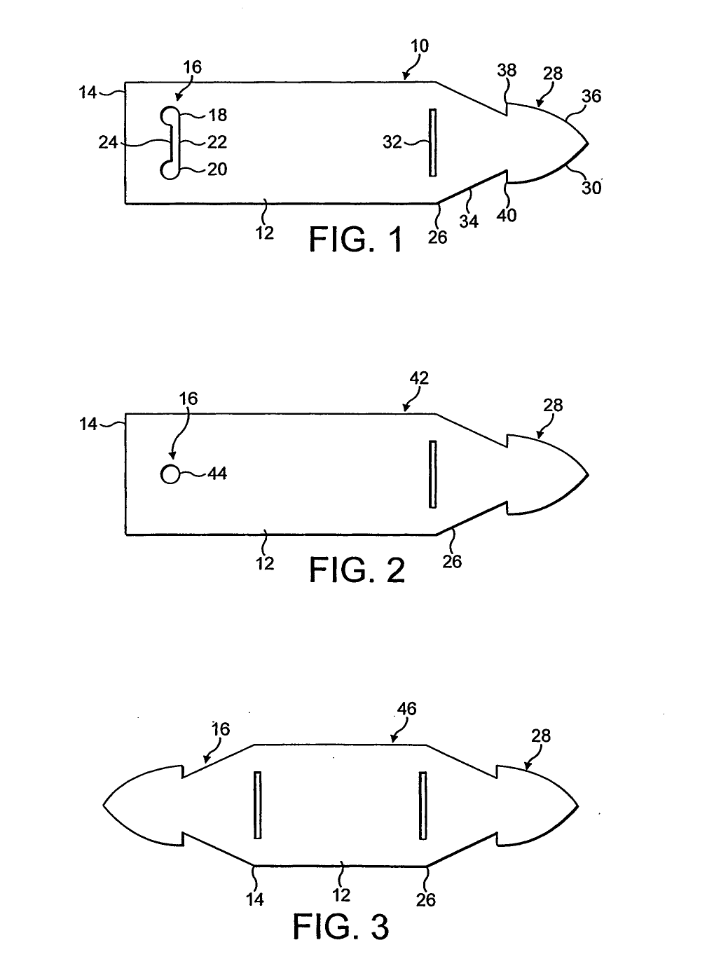

FIG. 1 is a plan view of a first tag in accordance with the invention,

FIG. 2 is a plan view of a second tag in accordance with the invention,

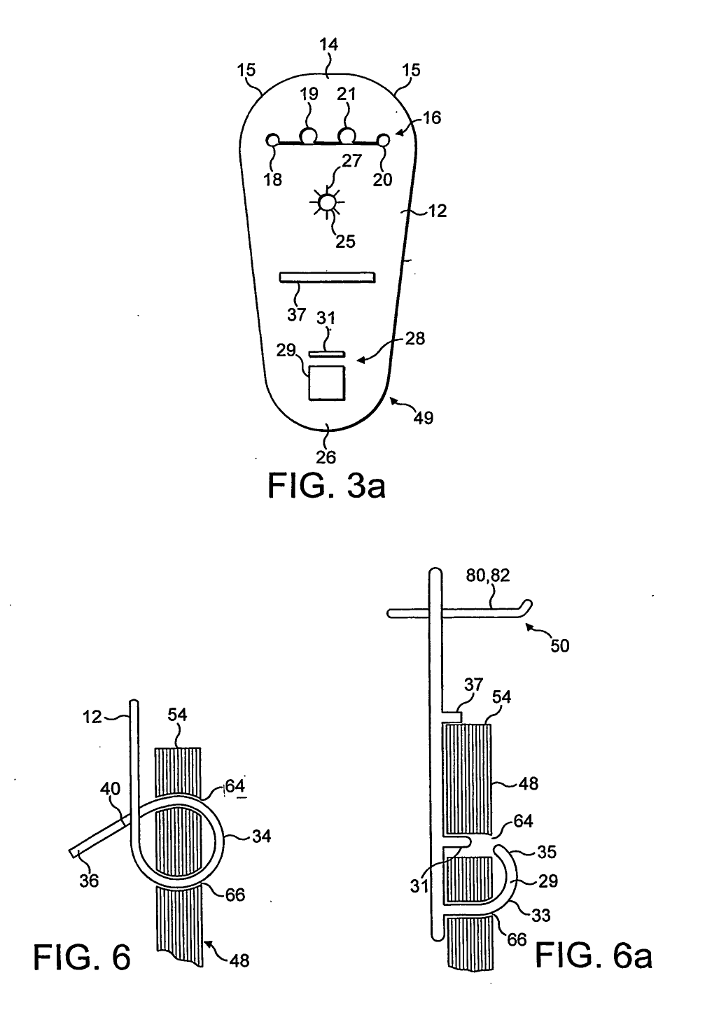

FIG. 3 is a plan view of a third tag in accordance with the invention,

FIG. 3a is a plan view of a fourth tag in accordance with the invention,

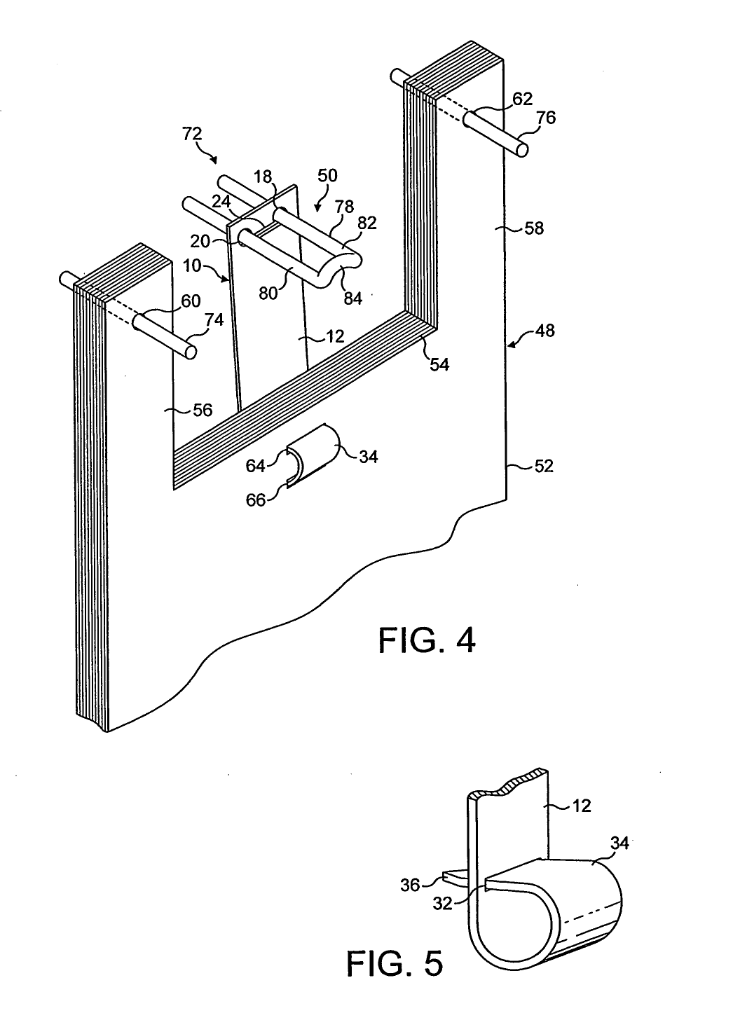

FIG. 4 is a perspective view of the tag of FIG. 1 supporting a stack of bags on a dispensing apparatus,

FIG. 5 is a perspective view of part of the tag of FIG. 1 showing the bag attachment formation, with the bags omitted for clarity,

FIG. 6 is a side elevation of the part of the tag of FIG. 5 shown attached to a stack of bags,

FIG. 6a is a side elevation of the part of the tag of FIG. 3a shown attached to a stack of bags,

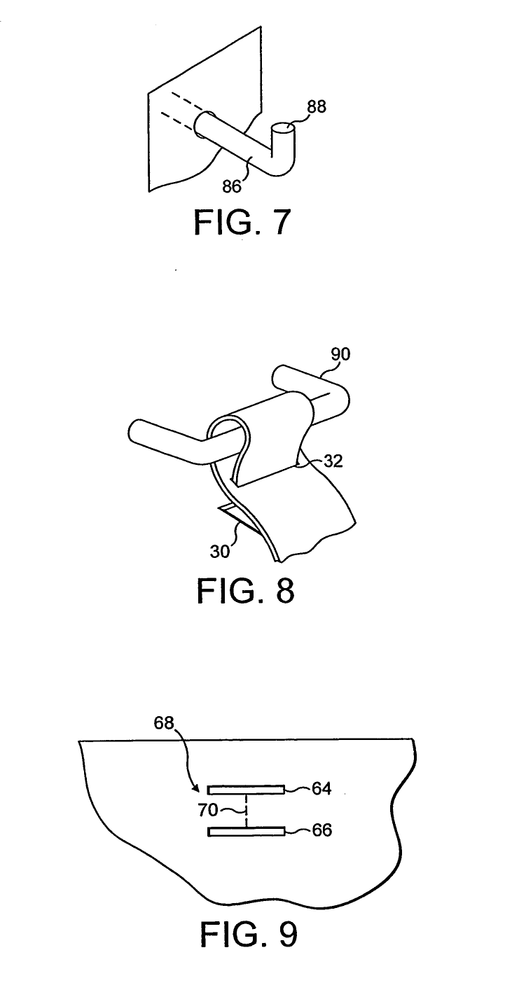

FIG. 7 is a perspective view of part of the tag of FIG. 2 on part of a dispensing apparatus,

FIG. 8 is a perspective view of part of the tag of FIG. 3 shown on part of a dispensing apparatus,

FIG. 9 is a front view of part of a bag in accordance with the invention,

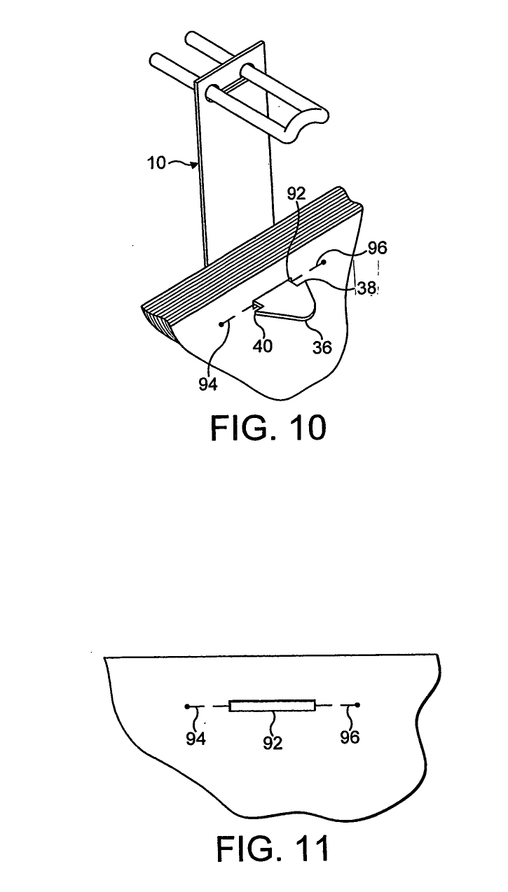

FIG. 10 is a perspective view of an alternative arrangement of tag and bag, and

FIG. 11 is a front view of part of the bag of FIG. 10.

In FIG. 1 a tag 10 comprises an elongate tag body 12 which is substantially rectangular. At one end 14 of the body 12 is a dispensing apparatus attachment formation 16. The dispensing apparatus attachment formation 16 comprises two circular apertures 18, 20 formed through the body 12 of the tag 10. The apertures 18, 20 are spaced apart and are connected by a slot 22, again formed through the body 12 of the tag 10. The slot 22 is formed offset from a line connecting the centre points of the apertures 18, 20 so as to define a tongue 24. At the other end 26 of the body 12, a bag attachment formation 28 is provided. The bag attachment formation 28 comprises an arrowhead formation 30 and a slit 32 formed through the body 12 of the tag 10. The arrowhead formation 30 comprises a tapered portion 34 which tapers inwardly from the end 26 of the rectangular tag body 12 and an arrowhead shaped portion 36 extending from the tapered portion 34 so as to define two barb-like projections 38,40 on opposite edges of the arrowhead 36.

The slit 32 runs perpendicular to the long dimension of the rectangular body 12 and is formed in line with the end 26 of the rectangular part of the body 12. The slit 32 is slightly smaller in length than the distance between the tips of the barbed members 38, 40.

In FIG. 2 a tag 42 is substantially similar to the tag shown in FIG. 1 and parts corresponding to parts in FIG. 1 carry the same reference numerals. Again, the tag comprises a substantially rectangular body 12 with opposite ends 14, 26. The bag attachment formation 28 is identical to that shown in FIG. 1. The dispensing apparatus attachment formation in FIG. 2 comprises a single circular aperture 44 arranged adjacent the end 14 of the tag 42.

In FIG. 3 a tag 46 is substantially identical to tags of FIGS. 1 and 2 and parts corresponding to parts in FIGS. 1 and 2 carry the same reference numerals.

Again, the tag 46 comprises an elongate rectangular body 12 having ends 14, 26. Again, the bag attachment formation 28 is identical to that shown in FIGS. 1 and 2. In FIG. 3, the dispensing apparatus attachment formation 16 is substantially similar to the bag attachment apparatus formation 28.

In FIG. 3a a tag 49 is similar to tags of FIGS. 1, 2, and 3 and parts corresponding to parts in FIGS. 1, 2, and 3 carry the same reference numerals.

The tag 49 comprises an elongate tag body 12 with an end 14 and end 26. The end 26 is curved, and end 14 has rounded corners 15. The tag body 12 is tapered from end 14 to end 26. End 14 has a dispensing apparatus attachment formation 16. The dispensing apparatus attachment formation 16 comprises two circular apertures 18, 20, and two further apertures 19,21 formed through the body 12 of the tag 10, the apertures 18, 20 being spaced apart with the two further apertures 19,21 positioned therebetween. Apertures 18,20 are connected by a slit 23, again formed through the body 12 of the tag 10, which also passes through apertures 19,21. The dispensing apparatus attachment formation 16 comprises an additional aperture 25 with radial slits 27 extending therefrom located between end 14 and end 26. Apertures 18,20, further apertures 19,21, and additional aperture 25, provide three different attachment formations enabling the tag 49 to be attachable to different dispensing apparatus (see below).

At the other end 26 of the body 12, a bag attachment formation 28 is provided. The bag attachment formation 28 comprises a lower protrusion in the form of a hook 29 extending from the body-12 of the tag 49, and an upper protrusion 31 extending from the body 12 of the tag 49 above the hook 29. The hook 29 decreases in thickness as it extends from the body 12 of the tag 49 such that a lower part 33 of the hook 29 has a thickness which is substantially thicker than an upper part 35 of the hook 29. The thickness of the upper protrusion 31 is substantially the same as the thickness of the upper part 35 of the hook 29.

The tag 49 further includes a ledge 37 extending from the body 12, the ledge 37 being positioned approximately half-way between the additional aperture 25 and the bag attachment formation 28.

In FIG. 4 the tag 10 of FIG. 1 is shown connected to a stack of bags 48 and mounted on a dispensing apparatus 50.

Each bag in the stack 48 comprises a substantially rectangular body 52 having closed sides and a closed base (not shown) and an open mouth end 54. Handles 56, 58 extend upwardly from the mouth end 54. Each handle 56, 58 has a hole 60, 62 punched therethrough towards the upper edge thereof. Each bag of the stack 52 shown in FIG. 4 has two spaced parallel slits 64, 66 (see also FIG. 9). The slits 64, 66 are arranged parallel with the mouth 54 of the bag and are spaced slightly downwardly of the body of the bag from the mouth 54. As shown in FIG. 9, slits 64, 66 have a weakened portion 68 of bag material arranged therebetween. The weakened portion is preferably effected by cutting a perforated line 70 perpendicular to the slit 64, 66 at the mid point of the slits.

The tag 10 is attached to the stack of bags 48 as shown in FIGS. 4-6. The attachment of the tag 10 to the stack 48 is effected by inserting the arrowhead 36 of the bag attachment formation 28 of the tag 10 through the lower slit 66 in the stack of bags from the back of stack 48 to the front and then bending over the tag body so as to insert the arrowhead 36 back through the slit 64 from the front of stack 48 to the back thereof. The arrowhead 36 is then pushed through the slit 32 in the tag body 12 until the barbs 38, 40 snaph through the slit 32 in resilient fashion. In that way, the bags are retained on the tag and pulling of the arrowhead 36 back through the slit 32 is restrained by abutment of the barbs 38, 40 on the body of the tag 12 on either side of the slit 32. That arrangement is best shown in FIGS. 5 and 6.

A conventional dispensing apparatus, as described above is provided. Part of the dispensing apparatus 72 is shown in FIG. 4. The dispensing apparatus 72 has two elongate pins 74, 76 which are spaced apart by the same distance as the distance between the apertures 60, 62 in the handles 56, 58 of the bags 52 of the stack 48.

The stack 48 is thus supported on the dispenser apparatus 72 by pushing the handles 56, 58 onto the pins 74, 76 by inserting the pins 74, 76 through the apertures 60, 62.

A central hooked projection 78 is provided. The projection 78 comprises two elongate wires 80, 82 with a connecting bight portion 84. The bight portion 84 is curved upwardly to form a hook-like formation. In order to attach the tag 10 to the projection 78, the projection 78 is pushed through the dispensing apparatus attachment formation 16. In so doing, the tongue 24 flexes resiliently by a sufficient amount to allow the bight portion 84 to pass through the slot 22. The apertures 18, 20 are dimensioned to accommodate the wires 80, 82 with a small clearance and once the bight portion 84 has passed through the slot 22, the tongue 24 snaps back resiliently into the space between the wires 80, 82 which serves to retain the tag on the projection 78.

When a user wishes to package purchased goods in a bag using the present arrangement, the front face of the front bag on the stack 48 is pulled forwardly which causes the perforated portion 70 between the slits 64, 66 to fail allowing the front face to be pulled forward. The handles 56, 58 of the front bag slide along the pins 74, 76. Only part of the pins 14, 76 are shown in FIG. 4 and, as described above, they extend beyond the end of the central projection 78. That allows the user to open the bag while the rear face of the bag is retained by the bag attachment formation 28 of the tag 10. Once the user has completed filling the bag, the handles can be pulled off the pins 74, 76 which, in turn causes the perforated portion 70 between the slits 64, 66 in the rear wall of the front most bag to fail.

In a preferred embodiment, the rear wall of the front most bag is attached in a semi-permanent manner to the front wall of the subsequent bag so as to pull the front wall forward.

If, during the course of a bag removal operation the tag 10 should slide along the central projection 78, the tongue 24 will abut the bight 84 to prevent the tag from being pulled off the central projection. When the stack of bags is exhausted, the tag 10 is left attached to the central projection 78. This is a better arrangement than the prior dispensing arrangements as the tag is positively located onto the central projection using the resilience of the tongue 24 which prevents the tag from being inadvertently removed from the central projection 78. A positive removal action is required. Also, because only the tag is attached to the central projection 78 and the central projection 78 is considerably shorter than the pin 74, 76, the prior systems were limited in the number of bags that could be mounted on the dispensing apparatus because they could only mount stacks of bags of equivalent thickness to the length of the central projection. In the present situation, multiple stacks of bags can be loaded because the thickness of the stack of bags does not affect the amount of stacks that can be loaded on the central projection 78.

FIG. 7 illustrates the mounting of the tag of FIG. 2 onto an alternative form of central projection which simply comprises a pin 86 having a hook-like formation 88 at the end thereof.

FIG. 8 illustrates the attachment of the tag of FIG. 3 to an alternative form of central projection 90 which simply comprises a U-shaped loop of material around which the arrowhead formation 30 can be looped back on itself through the slit 32 in the tag body. That arrangement is less preferable since only one stack of bags can be located but may be applicable where space is limited.

FIG. 6a illustrates the attachment of the tag 49 of FIG. 3a onto a dispenser 50 identical to that of FIG. 4. The tag 49 of FIG. 3a is shown connected to a stack of bags 48 identical to those shown in FIG. 4.

The tag 49 is attached to the stack of bags 48 by manipulating the tag 49 such that the hook 29 passes through slits 64,66 of the bags as shown in FIG. 6a. When manipulating the bags onto the hook 29, the ledge 37 abuts against the mouth end 54 of the bags so as to locate the hook 29 relative to the slits 64,66. The inherent shape of the hook 29 prevents the bags from being pulled of the tag 49. It can be seen that the bags are supported by the lower part 33 of the hook 29, i.e. the part of greater thickness, and therefore the hook is less likely to fail due to the weight of the bags.

In order to attach the tag 49 to the dispensing apparatus 50, the wires 80, 82 pass through apertures 18,20 in the same way as in with the tag of FIG. 1. The provision of the slit 23 allows the dispensing apparatus to pass through the body 12 of the tag 49. As described above, the provision of further holes 19,21, and additional hole 25 allows the tag 49 to be attached to alternative dispensing apparatus.

In FIGS. 10 and 11 an alternative form of bag attachment is shown in which one slit 92 is provided at the same point as the slit 64 in the bag shown in FIG. 4. In this case, the arrowhead 36 of the arrowhead formation 30 of the bag attachment formation 28 is inserted through the slit 92 and the slit 92 is provided with a controlled failure mechanism at each end thereof, as shown in FIG. 11 whereby perforated lines 94, 96 are cut from each end of the slit 92.

In that embodiment, pulling of the front face of the bag causes the barb portions 38, 40 to engage with the perforated lines 94, 96 which will cause those perforations to fail. The slot 92 is shorter in length than the distance between the barbed portions 38, 40 but when enlarged by failure of the perforated portions 94, 96 the barbs 38, 40 can clear the ends of the slit allowing the bag to be removed from the tag 10.

The tag is preferably made from flexible plastics material although the material chosen is preferably more rigid than the material from which the bags are made. Material is selected to provided sufficient resilience such that the tongue formation 24 of the tag 10 of FIG. 1 will flex appropriately when loaded onto the central projection 78 and the barb formation 38, 40 will flex sufficiently inwardly when inserted through the slots 64, 66 and 92 and the slit 32 in the body of the tag 10.

Advertising indicia or bag removal instructions could be printed on the body 12 of the tag which will be visible to the user, in use.

The above described arrangements are advantageous for the reasons described and in particular because stacks of bags can be provided with the tags pre-attached which simplifies the loading of stacks of bags on to the dispensing apparatus, saving staff time for retail establishments. Also, more stacks of bags can be located on conventional dispensing apparatus than are presently possible which, again, increases staff efficiency. The fact that the tag must be removed in a positive removal step rather than inadvertently results in improvements in the health and safety of operatives in stores.

1. A tag for supporting part of a bag on a bag dispensing apparatus, the tag comprising a body having a dispensing apparatus attachment formation at one end to allow attachment of the tag to dispensing apparatus and a bag attachment formation at the other end to allow attachment of a tag to part of a bag.

2. A tag according to claim 1 in which the dispensing apparatus attachment formation comprises an aperture in the tag body to allow a projecting member of the dispensing apparatus to pass therethrough.

3. A tag according to claim 2 in which the projecting member of the dispensing apparatus comprises a looped projection.

4. A tag according to claim 3 in which the aperture in the tag body includes a tongue which is arranged to project into the loop when the looped projection passes through the aperture.

5. A tag according to claim 3 or 4 in which the looped projection comprises two substantially parallel spaced arms with a connecting bight portion.

6. A tag according to claim 5 in which the aperture comprises two arm apertures spaced apart by the same distance as the spaced arms and being dimensioned to allow a respective arm therethrough with a clearance and a slot connecting the two arm apertures together.

7. A tag according to any preceding claim in which the bag attachment formation comprises an arrowhead formation at the end of the tag body which can project through an aperture in the bag, whereby the widest point of the arrowhead is wider than the bag aperture.

8. A tag according to claim 7 in which the arrowhead formation projects through one aperture in the bag and back through another aperture.

9. A tag according to claim 8 in which a slit is provided in the body of the tag so that the arrowhead projects through a first bag aperture, back through a second bag aperture and then through the slit in the body of the tab to retain the bags on the tag.

10. A tag according to any one of claims 1 to 6 in which the bag attachment formation comprises a hook-like protrusion which can project through an aperture in the bag.

11. A tag according to claim 10 in which the hook-like protrusion comprises an upper part and a lower supporting part, whereby the lower supporting part is of a greater thickness than the upper part.

12. A tag according to any preceding claim including a protruding ledge for abutment with a mouth end of a bag to enable alignment of the tag relative to the bag.

13. A tag according to any preceding claim in which the tag is made from a material which is stronger than the bag material.

14. A tag according to any preceding claim in which the tag has a greater thickness than the bag.

15. A tag according to any preceding claim in which the tag is made from a flexible plastics material.

16. A tag according to any preceding claim in which the tag is made from a resilient material such that the tongue is a snap-fit in the space between the arms.

17. A tag according to any preceding claim in which the tag is made from a resilient material such that the arrowhead arrangement is a snap-fit in the slit in the tag body.

18. A tag according to any preceding claim in which the dispensing apparatus attachment formation comprises two arm apertures connected by a slot so as to define a tongue therebetween at one end of the body and a bag attachment formation having an arrowhead and slit combination at the other end of the body.

19. A bag comprising a body having a closed base and closed side walls, handle members and an open mouth end, the bag further comprising two apertures adjacent the mouth end of the bag between the handle members and a weakened portion of bag material between the apertures.

20. A bag according to claim 19 including a tag according to any of claims 1 to 18 attached thereto.

21. A bag according to claim 20 in which the bag is a stack of bags.

22. A stack of bags including a tag according to any one of claims 1 to 18 attached thereto.

23. A dispensing apparatus carrying a stack of bags having a separate tag connecting the stack of bags with the dispensing apparatus.
